(19) United States
(12) Patent Application Publication
(10) Pub. No.: US 2019/0020750 A1
(43) Pub. Date: Jan. 17, 2019

(54) TERMINAL UNLOCKING METHOD AND APPARATUS, TERMINAL, AND BAND

(71) Applicant: HUAWEI TECHNOLOGIES CO., LTD., Shenzhen, Guangdong (CN)

(72) Inventors: Muyun QIN, Shenzhen (CN); Mengte ZHOU, Shanghai (CN); Xin YU, Shenzhen (CN); Ruimin WANG, Shenzhen (CN)

(21) Appl. No.: 16/068,275

(22) PCT Filed: Jan. 7, 2016
(86) PCT No.: PCT/CN2016/070428

§ 371 Date: Jul. 5, 2018

(51) Int. Cl. H04M 1/673; G06F 21/32; H04B 13/00; H04M 1/675

(52) U.S. Cl. CPC H04M 1/673; H04M 1/675; H04B 13/005; G06F 21/32

(57) ABSTRACT

The present disclosure relates to example terminal unlocking methods. One example method includes controlling, by at least one processor of a terminal using an analog front end (AFE), a transmit electrode of the terminal to send a bioelectric current. A communications connection is established between the terminal and a band when a receive electrode receives the bioelectric current. The terminal then receives an unlocking password sent by the band and performs unlocking according to the unlocking password.

### TECHNICAL FIELD

The present invention relates to the field of communications technologies, and in particular, to a terminal unlocking method and apparatus, a terminal, and a band.

### BACKGROUND

With development of communications technologies, particularly with popularization of bands, a user can use a band to unlock a mobile phone by using a Bluetooth technology and an RSSI (Received Signal Strength Indicator, received signal strength indicator). Currently, after a mobile phone is paired with a band, the mobile phone can detect Bluetooth signal strength between the mobile phone and the band. Then, when the signal strength meets a specific preset condition, the band can unlock the mobile phone by using Bluetooth.

However, when the foregoing method is used to unlock a mobile phone, the mobile phone needs to be as close to a band as possible to make Bluetooth signal strength between the band and the mobile phone meet a preset condition. If there is a relatively long distance between the mobile phone and the band, Bluetooth signal strength detected by the mobile phone is relatively weak and cannot meet the preset condition. Consequently, the mobile phone cannot be unlocked by using the band. Therefore, due to a relatively long distance between a band and a mobile phone, the band cannot successfully unlock the mobile phone. This reduces a success rate of unlocking the mobile phone by using the band.

### SUMMARY

Embodiments of the present invention provide a terminal unlocking method and apparatus, a terminal, and a band, so as to increase a success rate of unlocking a mobile phone by using a band.

To achieve the foregoing objective, the following technical solutions are used in the embodiments of the present invention.

According to a first aspect, an embodiment of the present invention provides a terminal unlocking method, where the method is used for a communications system, the communications system includes a terminal and a band, a transmit electrode is disposed at a first location on the terminal, a receive electrode is disposed at a second location on the terminal or disposed at a third location on the band, the terminal further includes a processor and an analog front end (AFE), and the method includes:

controlling, by the processor of the terminal by using the AFE, the transmit electrode of the terminal to send a bioelectric current;

completing establishment of a communications connection between the terminal and the band when the receive electrode receives the bioelectric current; and

receiving, by the terminal, an unlocking password sent by the band, and performing unlocking according to the unlocking password.

With reference to the first aspect, in a first possible implementation of the first aspect, the controlling, by the processor of the terminal by using the AFE, the transmit electrode of the terminal to send a bioelectric current includes:

when the terminal meets a preset pickup condition, controlling, by the processor of the terminal by using the AFE, the transmit electrode of the terminal to send the bioelectric current, where the preset pickup condition is that a path is formed between the transmit electrode and the receive electrode, and the path is used to transmit the bioelectric current.

With reference to the first aspect or the first possible implementation of the first aspect, in a second possible implementation of the first aspect, the completing establishment of a communications connection between the terminal and the band includes:

detecting, by the terminal, Bluetooth signal strength between the terminal and the band;

determining, by the terminal, a distance from the band to the terminal according to the signal strength; and

completing, by the terminal, establishment of the communications connection to the band when the distance is within a preset distance range.

With reference to the first possible implementation of the first aspect, in a third possible implementation of the first aspect, before the when the terminal meets a preset pickup condition, controlling, by the processor of the terminal by using the AFE, the transmit electrode of the terminal to send the bioelectric current, the method includes:

performing, by the terminal, pairing with the band by using Bluetooth/a wireless network (WI-FI)/a body area network (BAN), and establishing authentication.

With reference to any one of the first aspect, or the first to the third possible implementations of the first aspect, in a fourth possible implementation of the first aspect, the first location and the second location are respectively on two sides of the terminal, and the two sides are parallel to each other.

With reference to the first aspect or the first possible implementation of the first aspect, in a fifth possible implementation of the first aspect, the completing establishment of a communications connection between the terminal and the band includes:

completing, by the band, establishment of the communications connection to the terminal.

With reference to the fifth possible implementation of the first aspect, in a sixth possible implementation of the first aspect, the band includes a temperature sensor, and the method includes:

detecting, by the band by using the temperature sensor, a time period in which temperature meets a preset abnormality condition, where the preset abnormality condition is that the temperature is not within a preset temperature range; and

clearing, by the band, the unlocking password when the time period is longer than a preset time period.

According to a second aspect, an embodiment of the present invention provides a terminal unlocking apparatus, where the apparatus is used for a communications system, the communications system includes a terminal and a band, a transmit electrode is disposed at a first location on the terminal, a receive electrode is disposed at a second location on the terminal or disposed at a third location on the band, the terminal further includes a processor and an analog front end (AFE), and the apparatus includes:

a control module, configured to control, by using the AFE, the transmit electrode of the terminal to send a bioelectric current;

a communications module, configured to complete establishment of a communications connection between the terminal and the band when the receive electrode receives the bioelectric current; and

a receiving module, configured to receive an unlocking password sent by the band, and perform unlocking according to the unlocking password.

With reference to the second aspect, in a first possible implementation of the second aspect, the control module is specifically configured to: when the terminal meets a preset pickup condition, control, by using the AFE, the transmit electrode of the terminal to send the bioelectric current, where the preset pickup condition is that a path is formed between the transmit electrode and the receive electrode, and the path is used to transmit the bioelectric current.

With reference to the second aspect or the first possible implementation of the second aspect, in a second possible implementation of the second aspect, the communications module is disposed on the terminal, and is specifically configured to detect Bluetooth signal strength between the terminal and the band, determine a distance from the band to the terminal according to the signal strength, and complete establishment of the communications connection between the terminal and the band when the distance is within a preset distance range.

With reference to the first possible implementation of the second aspect, in a third possible implementation of the second aspect, the apparatus further includes:

an authentication module, configured to perform pairing with the band by using Bluetooth/a wireless network (WI-FI)/a body area network (BAN), and establish authentication.

With reference to any one of the second aspect, or the first to the third possible implementations of the second aspect, in a fourth possible implementation of the second aspect, the first location and the second location are respectively on two sides of the terminal, and the two sides are parallel to each other.

With reference to the second aspect or the first possible implementation of the second aspect, in a fifth possible implementation of the second aspect, the communications module is disposed on the band, and is specifically configured to complete establishment of the communications connection between the band and the terminal when the receive electrode receives the bioelectric current.

With reference to the fifth possible implementation of the second aspect, in a sixth possible implementation of the second aspect, the band includes a temperature sensor, and the apparatus further includes:

a detection module, configured to detect, by using the temperature sensor, a time period in which temperature meets a preset abnormality condition, where the preset abnormality condition is that the temperature is not within a preset temperature range; and

a processing module, configured to clear the unlocking password when the time period is longer than a preset time period.

According to a third aspect, an embodiment of the present invention provides a terminal, where the terminal is used for a communications system, the communications system includes the terminal and a band, a transmit electrode is disposed at a first location on the terminal, a receive electrode is disposed at a second location on the terminal or disposed at a third location on the band, the terminal further includes a first processor, an analog front end (AFE), and an interface circuit, where

the first processor is configured to control, by using the AFE, the transmit electrode of the terminal to send a bioelectric current;

the interface circuit is configured to complete establishment of a communications connection between the terminal and the band when the receive electrode receives the bioelectric current; and

the interface circuit is further configured to receive an unlocking password sent by the band, and perform unlocking according to the unlocking password.

With reference to the third aspect, in a first possible implementation of the third aspect, the first processor is specifically configured to: when the terminal meets a preset pickup condition, control, by using the AFE, the transmit electrode of the terminal to send the bioelectric current, where the preset pickup condition is that a path is formed between the transmit electrode and the receive electrode, and the path is used to transmit the bioelectric current.

With reference to the third aspect or the first possible implementation of the third aspect, in a second possible implementation of the third aspect, the interface circuit is specifically configured to detect Bluetooth signal strength between the terminal and the band, determine a distance from the band to the terminal according to the signal strength, and complete establishment of the communications connection between the terminal and the band when the distance is within a preset distance range.

With reference to the first possible implementation of the third aspect, in a third possible implementation of the third aspect, the interface circuit is further configured to perform pairing with the band by using Bluetooth/a wireless network (WI-FI)/a body area network (BAN), and establish authentication.

With reference to any one of the third aspect, or the first to the third possible implementations of the third aspect, in a fourth possible implementation of the third aspect, the first location and the second location are respectively on two sides of the terminal, and the two sides are parallel to each other.

According to a fourth aspect, an embodiment of the present invention provides a band, where the band is used for a communications system, the communications system includes a terminal and the band, a transmit electrode is disposed at a first location on the terminal, a receive electrode is disposed at a third location on the band, the terminal further includes a first processor and an analog front end (AFE), and the band includes an interface circuit, where

the interface circuit is configured to complete establishment of a communications connection between the band and the terminal when the processor of the terminal controls, by using the AFE, the transmit electrode of the terminal to send a bioelectric current and the receive electrode receives the bioelectric current; and

the interface circuit is further configured to send an unlocking password to the terminal, so that the terminal performs unlocking according to the unlocking password.

With reference to the fourth aspect, in a first possible implementation of the fourth aspect, the band includes a temperature sensor and a second processor, where

the temperature sensor is configured to detect a time period in which temperature meets a preset abnormality condition, where the preset abnormality condition is that the temperature is not within a preset temperature range; and

the second processor is configured to clear the unlocking password when the time period is longer than a preset time period.

According to the terminal unlocking method and apparatus, the terminal, and the band that are provided in the embodiments of the present invention, the processor of the terminal controls, by using the AFE, the transmit electrode of the terminal to send the bioelectric current. When the receive electrode receives the bioelectric current, establishment of the communications connection between the terminal and the band is completed. Then, the band sends the unlocking password to the terminal, and the terminal performs unlocking according to the received unlocking password. The receive electrode may be disposed at the second location on the terminal or the third location on the band. In the prior art, a mobile phone is placed close to a band to make Bluetooth signal strength between the mobile phone and the band meet a preset condition, so as to implement unlocking of the mobile phone by using the band. By comparison, in the embodiments of the present invention, both a transmit electrode and a receive electrode may be disposed on a mobile phone. Alternatively, in the embodiments of the present invention, a transmit electrode may be disposed on a mobile phone, and a receive electrode may be disposed on a band. Then, it is ensured that the receive electrode of the mobile phone or the receive electrode of the band can successfully receive a bioelectric current, so that the mobile phone can successfully obtain an unlocking password sent by the band and unlock the mobile phone. This avoids a case in which a mobile phone relatively far from a band cannot be successfully unlocked by using the band because Bluetooth signal strength between the mobile phone and the band limits mobile phone unlocking. Therefore, a success rate of unlocking a mobile phone by using a band is increased.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a terminal unlocking method according to an embodiment of the present invention;

FIG. 2 is a schematic structural diagram of a mobile phone according to an embodiment of the present invention.

FIG. 3 is a schematic structural diagram of another mobile phone according to an embodiment of the present invention.

FIG. 4 is a flowchart of another terminal unlocking method according to an embodiment of the present invention;

FIG. 5 is a schematic structural diagram of a circuit according to an embodiment of the present invention;

FIG. 6 is a flowchart of another terminal unlocking method according to an embodiment of the present invention;

FIG. 7 is a flowchart of another terminal unlocking method according to an embodiment of the present invention;

FIG. 8 is a flowchart of a terminal unlocking interaction according to an embodiment of the present invention;

FIG. 9 is a flowchart of another terminal unlocking method according to an embodiment of the present invention;

FIG. 10 is a schematic structural diagram of a terminal unlocking apparatus according to an embodiment of the present invention;

FIG. 11 is a schematic structural diagram of a terminal according to an embodiment of the present invention; and

FIG. 12 is a schematic structural diagram of a band according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

The embodiments of the present invention may be applied to a communications system. The communications system includes a terminal and a band. A transmit electrode may be disposed at a first location on the terminal, and a receive electrode may be disposed at a second location on the terminal. Alternatively, only a transmit electrode may be disposed at a first location on the terminal, and a receive electrode may be disposed at a third location on the band. The terminal may be a device such as a mobile phone or a pad. In the embodiments of the present invention, the mobile phone is used as an example, and the mobile phone is unlocked by using the band. It should be noted that, when a user holds the mobile phone by using a single hand, the single hand can simultaneously touch the first location and the second location on the mobile phone.

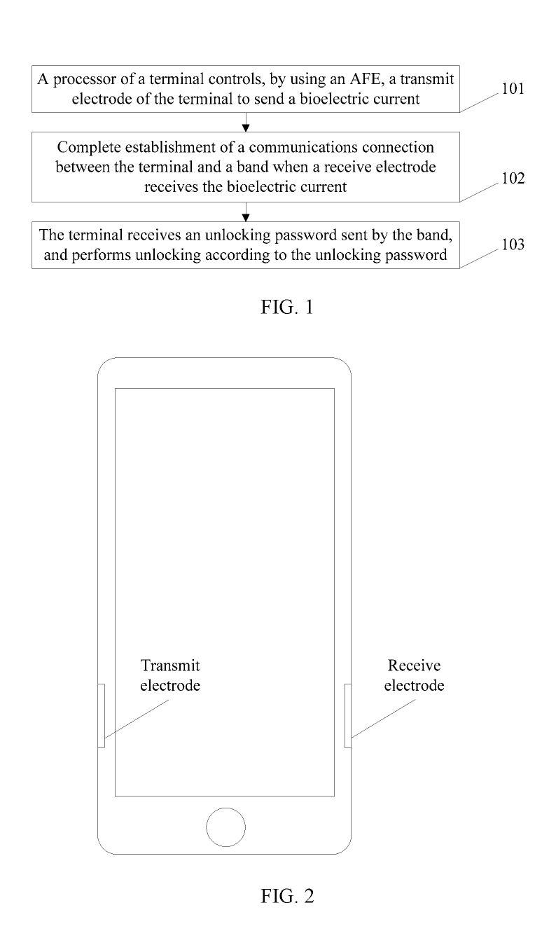

An embodiment of the present invention provides a terminal unlocking method. As shown in FIG. 1, the method is executed by a terminal. A transmit electrode is disposed at a first location on the terminal, and a receive electrode is disposed at a second location on the terminal or disposed at a third location on a band. The terminal further includes a processor and an AFE (Analog Front-End, analog front end). The method includes the following steps.

101: The processor of the terminal controls, by using the AFE, the transmit electrode of the terminal to send a bioelectric current.

To reduce energy that is consumed when the AFE is in a standby state, in this embodiment of the present invention, when a user simultaneously touches the first location and the second location on the mobile phone, or when a same user touches the first location on the mobile phone while wearing the band, that is, touching the third location on the band, both an acceleration sensor and an ultra-thin thermistor that are located on the terminal initiate an interrupt to a sensor hub (sensor hub), so as to trigger the sensor hub to enable the AFE. After the AFE is enabled, a bioelectric current is generated inside the AFE, and the AFE triggers, by using a digital-to-analog converter, the transmit electrode to send the bioelectric current. The bioelectric current passes through a human body loop of the user, and is received by the receive electrode on another side of the terminal. After the receive electrode receives the bioelectric current, the AFE is triggered to feed back, to the sensor hub, information that the receive electrode successfully receives the bioelectric current sent by the transmit electrode, so that when the sensor hub subsequently determines, according to information fed back by both the acceleration sensor and the ultra-thin thermistor that are located on the terminal, that the AFE needs to be disabled, the sensor hub is triggered to disable the AFE.

102: Complete establishment of a communications connection between the terminal and the band when the receive electrode receives the bioelectric current.

It should be noted that a process of completing establishment of the communications connection between the terminal and the band may be initiated by the terminal or the band. The device on which the receive electrode is located serves as an initiating end of the establishment process of the communications connection. In this case, a quantity of times of information interactions between the band and the terminal can be effectively reduced and efficiency of communications connection establishment can be improved compared with a case in which the device on which no receive electrode is disposed serves as an initiating end of the establishment process of the communications connection. That is, when the receive electrode is disposed at the second location, after the receive electrode receives the bioelectric current, the mobile phone on which the receive electrode is disposed may directly initiate a communications connection establishment request to the band. When the receive electrode is disposed at the third location, after the receive electrode receives the bioelectric current, the band on which the receive electrode is disposed may initiate a communications connection establishment request to the mobile phone.

When the transmit electrode is disposed at the first location and the receive electrode is disposed at the second location, the transmit electrode and the receive electrode may be respectively located on two sides of the terminal, and the two sides are parallel to each other. When the receive electrode of the terminal does not receive any bioelectric current sent by the transmit electrode, the terminal may enter a standby state, and a status of the terminal is monitored in real time. In this embodiment of the present invention, after the transmit electrode of the mobile phone sends the bioelectric current to the receive electrode of the mobile phone, when the receive electrode receives the bioelectric current, it is considered that the mobile phone is picked up by the user, and the user is likely to unlock the mobile phone. In this case, the mobile phone can enable communication with the band. As shown in FIG. 2, a mobile phone is used as an example. A transmit electrode and a receive electrode of the mobile phone may be respectively disposed on two sides of the mobile phone. That is, when a screen of the mobile phone directly faces a user, the transmit electrode and the receive electrode of the mobile phone are respectively located on the left side and the right side of the mobile phone. In addition, to ensure that the user can simultaneously touch the transmit electrode and the receive electrode of the mobile phone conveniently, the transmit electrode and the receive electrode may be respectively disposed in lower-middle parts, that is, locations close to a bottom, of the left side and the right side.

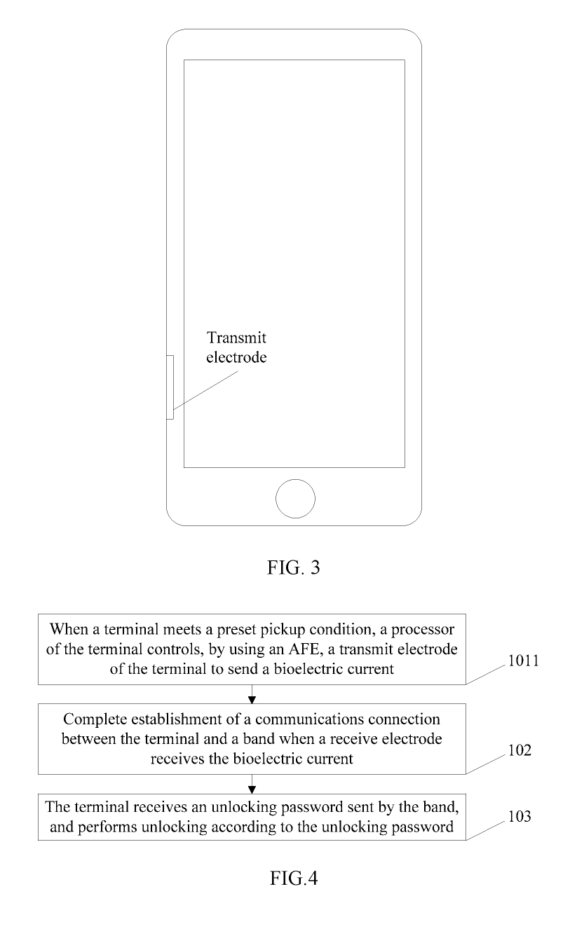

When the transmit electrode is disposed at the first location and the receive electrode is disposed at the third location, the transmit electrode of the mobile phone may be disposed on either of the two sides of the mobile phone. That is, when a screen of the mobile phone directly faces the user, the transmit electrode of the mobile phone is located on either of the left side and the right side of the mobile phone. In addition, to ensure that the user can conveniently touch the transmit electrode of the mobile phone, the transmit electrode may be disposed in a lower-middle part, that is, a location close to a bottom, of either of the left side and the right side. As shown in FIG. 3, FIG. 3 is a schematic diagram in which a transmit electrode of a mobile phone is disposed in a lower-middle part of a left side of the mobile phone. In this embodiment of the present invention, the terminal can send the bioelectric current to the receive electrode of the band by using the transmit electrode, so that the band completes establishment of the communications connection to the terminal. It should be noted that, to ensure that the band can successfully receive the bioelectric current sent by the transmit electrode of the terminal, the receive electrode is generally disposed on an inner side of the band, that is, a side close to skin of the user.

103: The terminal receives an unlocking password sent by the band, and performs unlocking according to the unlocking password.

In this embodiment of the present invention, after establishment of the communications connection between the terminal and the band is completed, the terminal may send a request message to the band, to successfully unlock the terminal. The request message carries an instruction used to trigger the band to send the unlocking password to the terminal, so that after the band receives the request message, the band sends a feedback message to the terminal, where the feedback message carries the unlocking password used to unlock the terminal. It should be noted that the terminal may send, to the band by using Bluetooth, Wi-Fi (WIreless-FIdelity, wireless network), or a BAN (Body Area Network, body area network), or in another manner, request information used for obtaining the unlocking password.

According to the terminal unlocking method provided in this embodiment of the present invention, the processor of the terminal controls, by using the AFE, the transmit electrode of the terminal to send the bioelectric current. When the receive electrode receives the bioelectric current, establishment of the communications connection between the terminal and the band is completed. Then, the terminal performs unlocking according to the received unlocking password. The receive electrode may be disposed at the second location on the terminal or the third location on the band. In the prior art, a mobile phone is placed close to a band to make Bluetooth signal strength between the mobile phone and the band meet a preset condition, so as to implement unlocking of the mobile phone by using the band. By comparison, in this embodiment of the present invention, both a transmit electrode and a receive electrode may be disposed on a mobile phone. Alternatively, in this embodiment of the present invention, a transmit electrode may be disposed on a mobile phone, and a receive electrode may be disposed on a band. Then, it is ensured that the receive electrode of the mobile phone or the receive electrode of the band can successfully receive a bioelectric current, so that the mobile phone can successfully obtain an unlocking password sent by the band and unlock the mobile phone. This avoids a case in which a mobile phone relatively far from a band cannot be successfully unlocked by using the band because Bluetooth signal strength between the mobile phone and the band limits mobile phone unlocking. Therefore, a success rate of unlocking a mobile phone by using a band is increased.

To avoid frequent wakeup of a system of the terminal, that is, to reduce energy consumption resulting from repetitive system wakeup when the terminal does not need to be unlocked, the terminal may be unlocked only when a user needs to unlock the terminal. In an implementation of this embodiment of the present invention, only when the terminal meets a preset pickup condition, the processor of the terminal is triggered to send the bioelectric current by using the AFE of the terminal. Therefore, based on the implementation shown in FIG. 1, alternatively, this embodiment may be implemented as an implementation shown in FIG. 4. Step 101 that the processor of the terminal controls, by using the AFE, the transmit electrode of the terminal to send a bioelectric current may be specifically implemented as step 1011:

1011: When the terminal meets a preset pickup condition, the processor of the terminal controls, by using the AFE, the transmit electrode of the terminal to send the bioelectric current.

The preset pickup condition is that a path is formed between the transmit electrode and the receive electrode, where the path is used to transmit the bioelectric current.

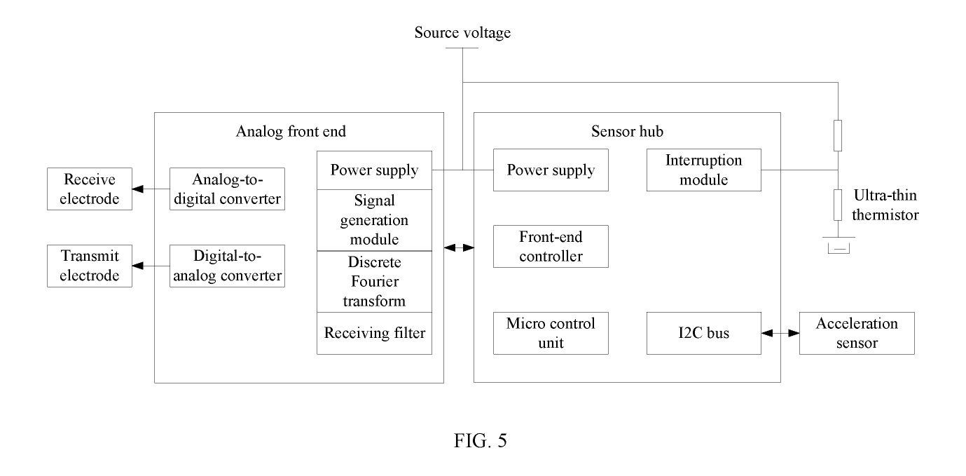

In this embodiment of the present invention, the acceleration sensor may be used to determine whether the terminal is picked up by the user, that is, to determine whether the terminal meets the preset pickup condition. When it is determined, by using the acceleration sensor, that the terminal meets the preset pickup condition, the processor of the terminal may enable the AFE, so that the AFE triggers the transmit electrode to send the bioelectric current. It should be noted that, in this embodiment of the present invention, the processor may be specifically a sensor hub. When the processor is the sensor hub, a circuit layout in the terminal is shown in FIG. 5. The acceleration sensor, the FTH (Flat Thin Head Thermistor, ultra-thin thermistor), the sensor hub, the AFE, the receive electrode, and the transmit electrode are disposed on the terminal. An analog-to-digital converter, the digital-to-analog converter, a power supply, a signal generation module, discrete Fourier transform (DFT, discrete Fourier transform), and a receiving filter are disposed in the AFE. A power supply, a front-end controller, a micro control unit, an I2C (inter-integrated circuit) bus, and an interruption (INT, interruption) module are disposed in the sensor hub. Power supplies of the AFE and the sensor hub are both connected to a VDD (Voltage Drain Drain, source voltage), and the AFE and the sensor hub can communicate with each other. The analog-to-digital converter disposed in the AFE may directly transfer a signal to the receive electrode. The digital-to-analog converter disposed in the AFE may directly transfer a signal to the transmit electrode. When the user picks up the terminal and holds the terminal, the acceleration sensor and the FTH initiate an interrupt to the sensor hub. After receiving the interrupt initiated by the FTH, the sensor hub enables the AFE.

According to the terminal unlocking method provided in this embodiment of the present invention, when the terminal meets the preset pickup condition, the processor of the terminal controls, by using the AFE, the transmit electrode of the terminal to send the bioelectric current. When the receive electrode receives the bioelectric current, establishment of the communications connection between the terminal and the band is completed. Then, the terminal performs unlocking according to the received unlocking password. The preset pickup condition is that the path used to transmit the bioelectric current is formed between the transmit electrode and the receive electrode. The receive electrode may be disposed at the second location on the terminal or the third location on the band. In the prior art, a mobile phone is placed close to a band to make Bluetooth signal strength between the mobile phone and the band meet a preset condition, so as to implement unlocking of the mobile phone by using the band. By comparison, in this embodiment of the present invention, both a transmit electrode and a receive electrode may be disposed on a mobile phone. Alternatively, in this embodiment of the present invention, a transmit electrode may be disposed on a mobile phone, and a receive electrode may be disposed on a band. Then, it is ensured that the receive electrode of the mobile phone or the receive electrode of the band can successfully receive a bioelectric current, so that the mobile phone can successfully obtain an unlocking password sent by the band and unlock the mobile phone. This avoids a case in which a mobile phone relatively far from a band cannot be successfully unlocked by using the band because Bluetooth signal strength between the mobile phone and the band limits mobile phone unlocking. Therefore, a success rate of unlocking a mobile phone by using a band is increased. In addition, only when the mobile phone meets the preset pickup condition, the processor of the mobile phone may be triggered to send the bioelectric current by using the AFE of the terminal. This avoids frequent system wakeup, that is, reduces energy consumption resulting from repetitive system wakeup when the terminal does not need to be unlocked.

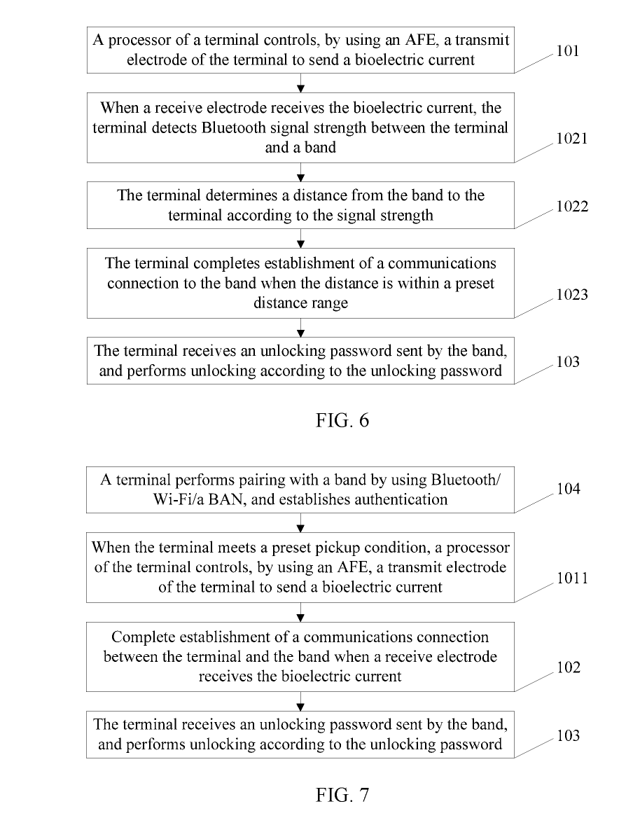

To prevent the terminal from being unlocked when the terminal and the band are not in a hand of a same user, in an implementation of this embodiment of the present invention, the terminal may determine a distance between the band and the terminal to determine whether an unlocking operation needs to be performed. Therefore, based on the implementation shown in FIG. 1, alternatively, this embodiment may be implemented as an implementation shown in FIG. 6. Step 102 of completing establishment of a communications connection between the terminal and the band when the receive electrode receives the bioelectric current may be specifically implemented as step 1021 to step 1023.

1021: When the receive electrode receives the bioelectric current, the terminal detects Bluetooth signal strength between the terminal and the band.

According to the method provided in this embodiment, the terminal is unlocked by using the band; the terminal may also be successfully unlocked when the band and the terminal are not in a hand of a same user. This reduces security of unlocking the terminal by using the band. Therefore, a distance between the band and the terminal may be limited by detecting Bluetooth signal strength between the band and the terminal, so as to improve security of unlocking the terminal by using the band.

1022: The terminal determines a distance from the band to the terminal according to the signal strength.

Bluetooth signal strength is positively correlated with a distance between the band and the terminal, that is, a shorter distance between the band and the terminal indicates higher Bluetooth signal strength. Therefore, in this embodiment of the present invention, the terminal may determine the distance between the band and the terminal according to the detected signal strength.

1023: The terminal completes establishment of the communications connection to the band when the distance is within a preset distance range.

It should be noted that the user may preset a signal strength threshold, that is, an upper limit of the preset range, according to a need of the user. When the distance between the band and the terminal determined according to the signal strength is within the preset range, the terminal establishes communication with the band. When the distance is not within the preset range, the terminal may enter a standby state, and a status of the terminal is monitored in real time.

According to the terminal unlocking method provided in this embodiment of the present invention, the processor of the terminal controls, by using the AFE, the transmit electrode of the terminal to send the bioelectric current. When the receive electrode receives the bioelectric current, the terminal determines the distance from the band to the terminal according to the detected Bluetooth signal strength between the terminal and the band. When the distance is within the preset distance range, the terminal completes establishment of the communications connection to the band. Then, the terminal performs unlocking according to the received unlocking password. The receive electrode may be disposed at the second location on the terminal or the third location on the band. In the prior art, a mobile phone is placed close to a band to make Bluetooth signal strength between the mobile phone and the band meet a preset condition, so as to implement unlocking of the mobile phone by using the band. By comparison, in this embodiment of the present invention, both a transmit electrode and a receive electrode may be disposed on a mobile phone. Alternatively, in this embodiment of the present invention, a transmit electrode may be disposed on a mobile phone, and a receive electrode may be disposed on a band. Then, it is ensured that the receive electrode of the mobile phone or the receive electrode of the band can successfully receive a bioelectric current, so that the mobile phone can successfully obtain an unlocking password sent by the band and unlock the mobile phone. This avoids a case in which a mobile phone relatively far from a band cannot be successfully unlocked by using the band because Bluetooth signal strength between the mobile phone and the band limits mobile phone unlocking. Therefore, a success rate of unlocking a mobile phone by using a band is increased. In addition, the terminal may determine the distance from the band to the terminal to determine whether an unlocking operation needs to be performed, so as to prevent the terminal from being unlocked when the terminal and the band are not in a hand of a same user. This improves security of unlocking the mobile phone by using the band.

To ensure security in a communication process, in an implementation of this embodiment of the present invention, the terminal may perform pairing with the band in advance, and establish authentication. Therefore, based on the implementation shown in FIG. 4, alternatively, this embodiment may be implemented as an implementation shown in FIG. 7. Step 104 may further be performed before performing step 1011 that when the terminal meets a preset pickup condition, the processor of the terminal controls, by using the AFE, the transmit electrode of the terminal to send the bioelectric current.

104: The terminal performs pairing with the band by using Bluetooth/Wi-Fi/a BAN, and establishes authentication.

In this embodiment of the present invention, to ensure that the terminal and the band can communicate with each other and to ensure security in a communication process, the terminal needs to perform pairing with the band in advance by using Bluetooth, Wi-Fi, or a BAN, or in another manner, and establish authentication.

According to the terminal unlocking method provided in this embodiment of the present invention, the terminal performs pairing with the band by using Bluetooth/Wi-Fi/a BAN, and establishes authentication. Then, the processor of the terminal controls, by using the AFE, the transmit electrode of the terminal to send the bioelectric current. When the receive electrode receives the bioelectric current, establishment of the communications connection between the terminal and the band is completed. Then, the band sends the unlocking password to the terminal, and the terminal performs unlocking according to the received unlocking password. The receive electrode may be disposed at the second location on the terminal or the third location on the band. In the prior art, a mobile phone is placed close to a band to make Bluetooth signal strength between the mobile phone and the band meet a preset condition, so as to implement unlocking of the mobile phone by using the band. By comparison, in this embodiment of the present invention, both a transmit electrode and a receive electrode may be disposed on a mobile phone. Alternatively, in this embodiment of the present invention, a transmit electrode may be disposed on a mobile phone, and a receive electrode may be disposed on a band. Then, it is ensured that the receive electrode of the mobile phone or the receive electrode of the band can successfully receive a bioelectric current, so that the mobile phone can successfully obtain an unlocking password sent by the band and unlock the mobile phone. This avoids a case in which a mobile phone relatively far from a band cannot be successfully unlocked by using the band because Bluetooth signal strength between the mobile phone and the band limits mobile phone unlocking. Therefore, a success rate of unlocking a mobile phone by using a band is increased. In addition, the mobile phone may perform pairing with the band in advance by using Bluetooth, Wi-Fi, or a BAN, or in another manner, and establish authentication, so as to ensure security in a process of communication between the terminal and the band.

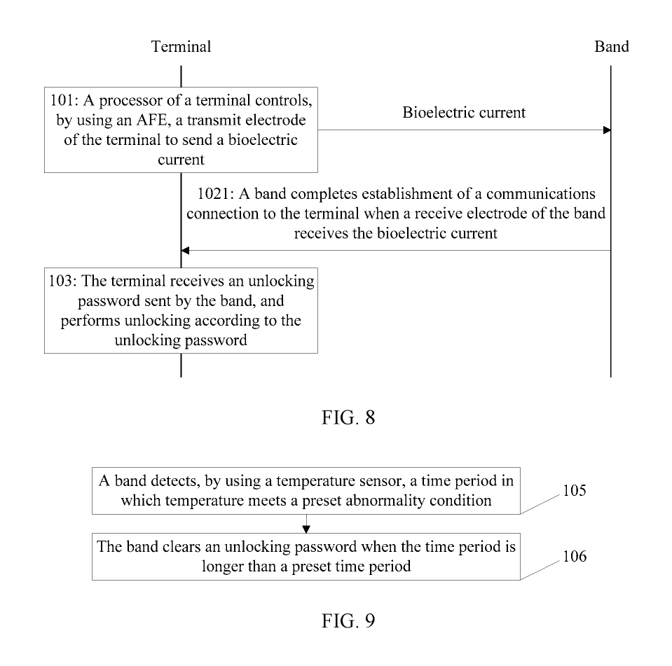

Establishment of the communications connection between the terminal and the band may be performed by the terminal serving as an initiating end, or performed by the band serving as an initiating end. In an implementation of this embodiment of the present invention, the method is executed by both the terminal and the band. The transmit electrode is disposed at a first preset location on the terminal. The terminal further includes the processor and the AFE. The receive electrode is disposed at a third preset location on the band. Based on the implementation shown in FIG. 1, alternatively, this embodiment may be implemented as an implementation shown in FIG. 8. Step 102 of completing establishment of a communications connection between the terminal and the band when the receive electrode receives the bioelectric current may be specifically implemented as step 1021 that the band completes establishment of the communications connection to the terminal when the receive electrode receives the bioelectric current. Step 1021 is performed by the band.

1021: The band completes establishment of the communications connection to the terminal when the receive electrode of the band receives the bioelectric current.

According to the terminal unlocking method provided in this embodiment of the present invention, the band completes establishment of the communications connection to the terminal when the receive electrode of the band receives the bioelectric current sent by the transmit electrode of the terminal. Then, the band sends the unlocking password to the terminal, so that the terminal performs unlocking according to the unlocking password. In the prior art, a mobile phone is placed close to a band to make Bluetooth signal strength between the mobile phone and the band meet a preset condition, so as to implement unlocking of the mobile phone by using the band. By comparison, in this embodiment of the present invention, a transmit electrode may be disposed on a mobile phone, and a receive electrode may be disposed on a band. Then, it is ensured that the receive electrode of the band can successfully receive a bioelectric current, so that the mobile phone can successfully obtain an unlocking password sent by the band and unlock the mobile phone. This avoids a case in which a mobile phone relatively far from a band cannot be successfully unlocked by using the band because Bluetooth signal strength between the mobile phone and the band limits mobile phone unlocking. Therefore, a success rate of unlocking a mobile phone by using a band is increased.

To ensure security of unlocking the terminal by using the band, that is, to ensure that the terminal cannot be unlocked by using the band when the band is stolen or is not worn on a wrist, in an implementation of this embodiment of the present invention, as shown in FIG. 9, the method further includes step 105 and step 106 that are performed by the band.

105: The band detects, by using a temperature sensor, a time period in which temperature meets a preset abnormality condition.

The preset abnormality condition is that the temperature is not within a preset temperature range. In this embodiment of the present invention, the preset temperature range may be specifically a normal body temperature range of a human body. That is, the band can determine, according to the temperature detected by the temperature sensor, whether the band is currently in a worn state. When the band is not in the worn state, that is, when the temperature detected by the temperature sensor is not within the preset temperature range, indicating that the band is not in the worn state, the band may be stolen.

In this embodiment of the present invention, alternatively, another sensor other than the temperature sensor may be used to determine whether the unlocking password on the band needs to be cleared. For example, when an acceleration sensor is disposed on the band, the band may use the acceleration sensor to determine whether the band has not generated any acceleration within a specific preset time period, that is, to determine whether the band remains at a same location for a long period of time, so as to determine whether the unlocking password on the band needs to be cleared. It should be noted that, to ensure that a process of clearing the unlocking password can improve security, the band may further use multiple sensors or another apparatus to monitor a status of the band, so as to clear the unlocking password on the band at an appropriate occasion.

106: The band clears the unlocking password when the time period is longer than a preset time period.

It should be noted that security of unlocking the mobile phone by using the band can be effectively ensured by using a method for clearing the unlocking password on the band. Therefore, even if the band is lost or both the band and the mobile phone are lost, no person other than the user can unlock the mobile phone.

According to the terminal unlocking method provided in this embodiment of the present invention, the band may detect, by using the temperature sensor, the time period in which the temperature meets the preset abnormality condition. When the time period is longer than the preset time period, the band may clear the unlocking password. The preset abnormality condition is that the temperature is not within the preset temperature range. In the prior art, a mobile phone is placed close to a band to make Bluetooth signal strength between the mobile phone and the band meet a preset condition, so as to implement unlocking of the mobile phone by using the band. By comparison, in this embodiment of the present invention, a transmit electrode may be disposed on a mobile phone, and a receive electrode may be disposed on a band. Then, it is ensured that the receive electrode of the band can successfully receive a bioelectric current, so that the mobile phone can successfully obtain an unlocking password sent by the band and unlock the mobile phone. This avoids a case in which a mobile phone relatively far from a band cannot be successfully unlocked by using the band because Bluetooth signal strength between the mobile phone and the band limits mobile phone unlocking. Therefore, a success rate of unlocking a mobile phone by using a band is increased. In addition, the band can monitor a temperature status around the band by using the temperature sensor, to determine whether the band is away from the user for a long period of time. When the band is away from the user for a long period of time, the unlocking password on the band is cleared. In this way, security of unlocking the mobile phone by using the band is effectively ensured.

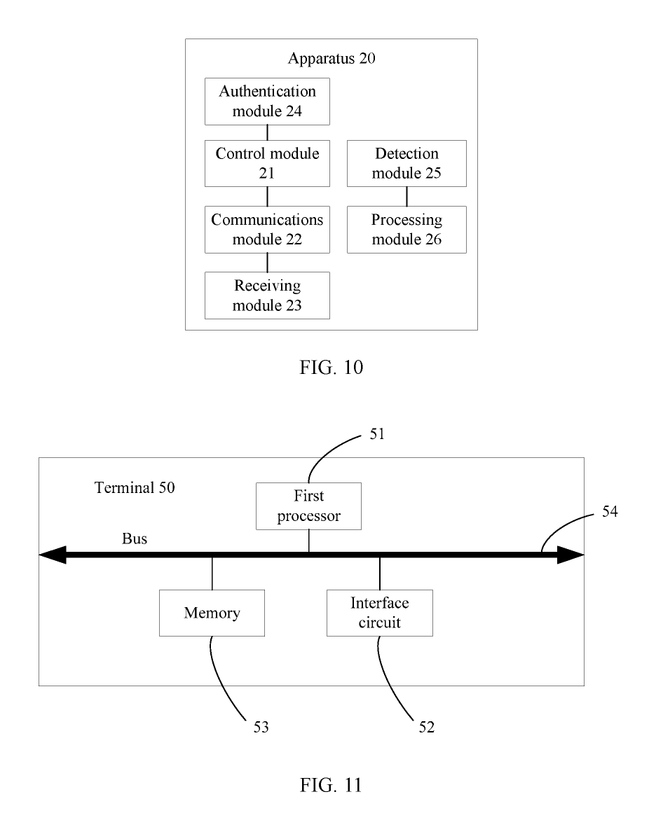

An embodiment of the present invention provides a terminal unlocking apparatus 20. As shown in FIG. 10, the apparatus 20 is configured to implement the method process shown in FIG. 1, FIG. 4, FIG. 6, FIG. 7, or FIG. 9, or the interaction process shown in FIG. 8. The apparatus 20 is used for a communications system. The communications system includes a terminal and a band. A transmit electrode is disposed at a first location on the terminal. A receive electrode is disposed at a second location on the terminal or disposed at a third location on the band. The terminal further includes a processor and an analog front end (AFE). The apparatus 20 includes:

a control module 21, configured to control, by using the AFE, the transmit electrode of the terminal to send a bioelectric current;

a communications module 22, configured to complete establishment of a communications connection between the terminal and the band when the receive electrode receives the bioelectric current; and

a receiving module 23, configured to receive an unlocking password sent by the band, and perform unlocking according to the unlocking password.

In an implementation of this embodiment of the present invention, the control module 21 is specifically configured to: when the terminal meets a preset pickup condition, control, by using the AFE, the transmit electrode of the terminal to send the bioelectric current. The preset pickup condition is that a path is formed between the transmit electrode and the receive electrode. The path is used to transmit the bioelectric current.

In an implementation of this embodiment of the present invention, the communications module 22 is disposed on the terminal, and is specifically configured to detect Bluetooth signal strength between the terminal and the band, determine a distance from the band to the terminal according to the signal strength, and complete establishment of the communications connection between the terminal and the band when the distance is within a preset distance range.

In an implementation of this embodiment of the present invention, the apparatus 20 further includes:

an authentication module 24, configured to perform pairing with the band by using Bluetooth/a wireless network (WI-FI)/a body area network (BAN), and establish authentication.

It should be noted that the first location and the second location are respectively on two sides of the terminal, and the two sides are parallel to each other.

In an implementation of this embodiment of the present invention, the communications module 22 is disposed on the band, and is specifically configured to complete establishment of the communications connection between the band and the terminal when the receive electrode receives the bioelectric current.

In an implementation of this embodiment of the present invention, the band includes a temperature sensor, and the apparatus 20 further includes:

a detection module 25, configured to detect, by using the temperature sensor, a time period in which temperature meets a preset abnormality condition, where the preset abnormality condition is that the temperature is not within a preset temperature range; and

a processing module 26, configured to clear the unlocking password when the time period is longer than a preset time period.

This embodiment of the present invention provides the terminal unlocking apparatus. The processor of the terminal controls, by using the AFE, the transmit electrode of the terminal to send the bioelectric current. When the receive electrode receives the bioelectric current, establishment of the communications connection between the terminal and the band is completed. Then, the band sends the unlocking password to the terminal, and the terminal performs unlocking according to the received unlocking password. The receive electrode may be disposed at the second location on the terminal or the third location on the band. In the prior art, a mobile phone is placed close to a band to make Bluetooth signal strength between the mobile phone and the band meet a preset condition, so as to implement unlocking of the mobile phone by using the band. By comparison, in this embodiment of the present invention, both a transmit electrode and a receive electrode may be disposed on a mobile phone. Alternatively, in this embodiment of the present invention, a transmit electrode may be disposed on a mobile phone, and a receive electrode may be disposed on a band. Then, it is ensured that the receive electrode of the mobile phone or the receive electrode of the band can successfully receive a bioelectric current, so that the mobile phone can successfully obtain an unlocking password sent by the band and unlock the mobile phone. This avoids a case in which a mobile phone relatively far from a band cannot be successfully unlocked by using the band because Bluetooth signal strength between the mobile phone and the band limits mobile phone unlocking. Therefore, a success rate of unlocking a mobile phone by using a band is increased.

An embodiment of the present invention provides a terminal 50. As shown in FIG. 11, the terminal 50 is configured to implement the method process shown in FIG. 1, FIG. 4, FIG. 6, or FIG. 7, or the interaction process shown in FIG. 8. The terminal 50 is used for a communications system. The communications system includes the terminal 50 and a band. A transmit electrode is disposed at a first location on the terminal 50. A receive electrode is disposed at a second location on the terminal 50 or disposed at a third location on the band. The terminal 50 further includes a first processor and an analog front end (AFE). The figure further shows a memory 53 and a bus 54. The first processor 51, an interface circuit 52, and the memory 53 are connected to and communicate with each other by using the bus 54.

It should be noted that the first processor 51 herein may be one processing element or may be a general designation of multiple processing elements. For example, the processing element may be a central processing unit (Central Processing Unit, CPU), may be an application-specific integrated circuit (Application Specific Integrated Circuit, ASIC), or may be configured as one or more integrated circuits implementing this embodiment of the present invention, for example, one or more microprocessors (digital signal processor, DSP), or one or more field programmable gate arrays (Field Programmable Gate Array, FPGA).

The memory 53 may be a storage apparatus, or may be a general designation of multiple storage elements, and is configured to store executable program code, or a parameter, data, and the like required for running of an access network management device. In addition, the memory 83 may include a random access memory (RAM), and may also include a non-volatile memory (non-volatile memory), for example, a magnetic disk memory or a flash memory (Flash).

The bus 54 may be an Industry Standard Architecture (Industry Standard Architecture, ISA) bus, a Peripheral Component Interconnect (Peripheral Component, PCI) bus, an Extended Industry Standard Architecture (Extended Industry Standard Architecture, EISA) bus, or the like. The bus 54 may be classified into an address bus, a data bus, a control bus, and the like. For convenience of denotation, the bus 54 is represented by using only one bold line in FIG. 11. However, it does not indicate that there is only one bus or only one type of bus.

The terminal 50 may further include an input and output apparatus that is connected to the bus 54, so as to connect to the processor 51 and other parts by using the bus 54.

The first processor 51 invokes the program code in the memory 53, to perform the operations performed by the terminal 50 in the foregoing method embodiment. For example, the operations include the following:

The first processor 51 is configured to control, by using the AFE, the transmit electrode of the terminal 50 to send a bioelectric current.

The interface circuit 52 is configured to complete establishment of a communications connection between the terminal 50 and the band when the receive electrode receives the bioelectric current.

The interface circuit 52 is further configured to receive an unlocking password sent by the band, and perform unlocking according to the unlocking password.

In an implementation of this embodiment of the present invention, the first processor 51 is specifically configured to: when the terminal 50 meets a preset pickup condition, control, by using the AFE, the transmit electrode of the terminal 50 to send the bioelectric current. The preset pickup condition is that a path is formed between the transmit electrode and the receive electrode. The path is used to transmit the bioelectric current.

In an implementation of this embodiment of the present invention, the interface circuit 52 is specifically configured to detect Bluetooth signal strength between the terminal 50 and the band, determine a distance from the band to the terminal 50 according to the signal strength, and complete establishment of the communications connection between the terminal 50 and the band when the distance is within a preset distance range.

In an implementation of this embodiment of the present invention, the interface circuit 52 is further configured to perform pairing with the band by using Bluetooth/a wireless network (WI-FI)/a body area network (BAN), and establish authentication.

It should be noted that the first location and the second location are respectively on two sides of the terminal 50, and the two sides are parallel to each other.

According to the terminal provided in this embodiment of the present invention, the processor of the terminal controls, by using the AFE, the transmit electrode of the terminal to send the bioelectric current. When the receive electrode receives the bioelectric current, establishment of the communications connection between the terminal and the band is completed. Then, the terminal performs unlocking according to the received unlocking password. The receive electrode may be disposed at the second location on the terminal or the third location on the band. In the prior art, a mobile phone is placed close to a band to make Bluetooth signal strength between the mobile phone and the band meet a preset condition, so as to implement unlocking of the mobile phone by using the band. By comparison, in this embodiment of the present invention, both a transmit electrode and a receive electrode may be disposed on a mobile phone. Alternatively, in this embodiment of the present invention, a transmit electrode may be disposed on a mobile phone, and a receive electrode may be disposed on a band. Then, it is ensured that the receive electrode of the mobile phone or the receive electrode of the band can successfully receive a bioelectric current, so that the mobile phone can successfully obtain an unlocking password sent by the band and unlock the mobile phone. This avoids a case in which a mobile phone relatively far from a band cannot be successfully unlocked by using the band because Bluetooth signal strength between the mobile phone and the band limits mobile phone unlocking. Therefore, a success rate of unlocking a mobile phone by using a band is increased.

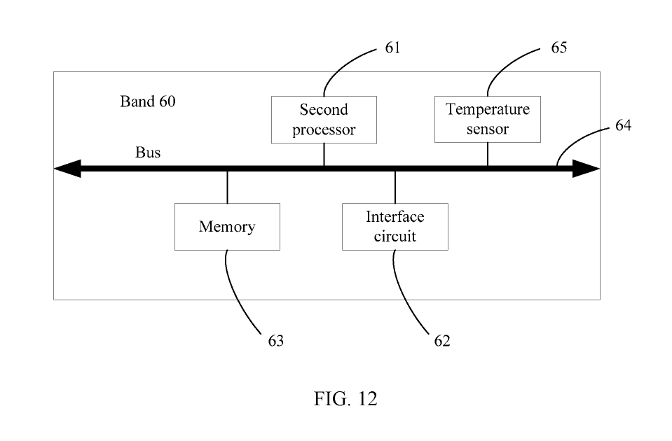

An embodiment of the present invention provides a band 60. As shown in FIG. 12, the band 60 is configured to implement the interaction process shown in FIG. 8 or the method process shown in FIG. 9. The band 60 is used for a communications system. The communications system includes a terminal and the band 60. A transmit electrode is disposed at a first location on the terminal. A receive electrode is disposed at a third location on the band 60. The terminal further includes a first processor and an analog front end (AFE). The band 60 includes a second processor 61, an interface circuit 62, and a temperature sensor 65. The figure further shows a memory 63 and a bus 64. The second processor 61, the interface circuit 62, the memory 63, and the temperature sensor 65 are connected to and communicate with each other by using the bus 64.

It should be noted that the second processor 61 herein may be one processing element or may be a general designation of multiple processing elements. For example, the processing element may be a central processing unit (Central Processing Unit, CPU), may be an application-specific integrated circuit (Application Specific Integrated Circuit, ASIC), or may be configured as one or more integrated circuits implementing this embodiment of the present invention, for example, one or more microprocessors (digital signal processor, DSP), or one or more field programmable gate arrays (Field Programmable Gate Array, FPGA).

The memory 63 may be a storage apparatus, or may be a general designation of multiple storage elements, and is configured to store executable program code, or a parameter, data, and the like required for running of an access network management device. In addition, the memory 83 may include a random access memory (RAM), and may also include a non-volatile memory (non-volatile memory), for example, a magnetic disk memory or a flash memory (Flash).

The bus 64 may be an Industry Standard Architecture (Industry Standard Architecture, ISA) bus, a Peripheral Component Interconnect (Peripheral Component, PCI) bus, an Extended Industry Standard Architecture (Extended Industry Standard Architecture, EISA) bus, or the like. The bus 64 may be classified into an address bus, a data bus, a control bus, and the like. For convenience of denotation, the bus 64 is represented by using only one bold line in FIG. 12. However, it does not indicate that there is only one bus or only one type of bus.

The band 60 may further include an input and output apparatus that is connected to the bus 64, so as to connect to the processor 61 and other parts by using the bus 64.

The second processor 61 invokes the program code in the memory 63, to perform the operations performed by the band 60 in the foregoing method embodiment. For example, the operations include the following:

The interface circuit 62 is configured to complete establishment of a communications connection between the band 60 and the terminal when the processor of the terminal controls, by using the AFE, the transmit electrode of the terminal to send a bioelectric current and the receive electrode receives the bioelectric current.

The interface circuit 62 is further configured to send an unlocking password to the terminal, so that the terminal performs unlocking according to the unlocking password.

In an implementation of this embodiment of the present invention, the temperature sensor 65 is configured to detect a time period in which temperature meets a preset abnormality condition. The preset abnormality condition is that the temperature is not within a preset temperature range.

The second processor 61 is configured to clear the unlocking password when the time period is longer than a preset time period.

According to the band provided in this embodiment of the present invention, when the receive electrode of the band receives the bioelectric current sent by the transmit electrode of the terminal, the band completes establishment of the communications connection to the terminal. Then, the band sends the unlocking password to the terminal, so that the terminal performs unlocking according to the unlocking password. In the prior art, a mobile phone is placed close to a band to make Bluetooth signal strength between the mobile phone and the band meet a preset condition, so as to implement unlocking of the mobile phone by using the band. By comparison, in this embodiment of the present invention, a transmit electrode may be disposed on a mobile phone, and a receive electrode may be disposed on a band. Then, it is ensured that the receive electrode of the band can successfully receive a bioelectric current, so that the mobile phone can successfully obtain an unlocking password sent by the band and unlock the mobile phone. This avoids a case in which a mobile phone relatively far from a band cannot be successfully unlocked by using the band because Bluetooth signal strength between the mobile phone and the band limits mobile phone unlocking. Therefore, a success rate of unlocking a mobile phone by using a band is increased.

The embodiments in this specification are all described in a progressive manner. Same or similar parts between the embodiments may be referenced to each other. Each embodiment focuses on a difference from other embodiments. Especially, a device embodiment is basically similar to a method embodiment, and therefore is described briefly; for related content, refer to a part of the descriptions in the method embodiment.

A person of ordinary skill in the art may understand that all or a part of the processes of the methods in the foregoing embodiments may be implemented by a computer program instructing relevant hardware. The program may be stored in a computer readable storage medium. When the program runs, the processes in the embodiments of the foregoing methods may be included. The storage medium may be a magnetic disk, an optical disc, a read-only memory (Read-Only Memory, ROM), a random access memory (Random Access Memory, RAM), or the like.

The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

1. A terminal unlocking method used for a communications system, wherein the communications system comprises a terminal and a band, a transmit electrode is disposed at a first location on the terminal, a receive electrode is disposed at a second location on the terminal or disposed at a third location on the band, the terminal further comprises at least one processor and an analog front end (AFE), and the method comprises:
controlling, by the at least one processor of the terminal using the AFE, the transmit electrode of the terminal to send a bioelectric current;
completing establishment of a communications connection between the terminal and the band when the receive electrode receives the bioelectric current; and
receiving, by the terminal, an unlocking password sent by the band, and performing unlocking according to the unlocking password.

2. The method according to claim 1, wherein the controlling, by the at least one processor of the terminal using the AFE, the transmit electrode of the terminal to send a bioelectric current comprises:
when the terminal meets a preset pickup condition, controlling, by the at least one processor of the terminal using the AFE, the transmit electrode of the terminal to send the bioelectric current, wherein the preset pickup condition is that a path is formed between the transmit electrode and the receive electrode, and the path is used to transmit the bioelectric current.

3. The method according to claim 2, wherein the completing establishment of a communications connection between the terminal and the band comprises:
detecting, by the terminal, Bluetooth signal strength between the terminal and the band;
determining, by the terminal, a distance from the band to the terminal according to the signal strength; and
completing, by the terminal, establishment of the communications connection to the band when the distance is within a preset distance range.

4. The method according to claim 2, before the when the terminal meets a preset pickup condition, controlling, by the at least one processor of the terminal using the AFE, the transmit electrode of the terminal to send the bioelectric current, comprising:
performing, by the terminal, pairing with the band using Bluetooth, and establishing authentication.

5. The method according to claim 1, wherein the first location and the second location are respectively on two sides of the terminal, and the two sides are parallel to each other.

6. The method according to claim 1, wherein the completing establishment of a communications connection between the terminal and the band comprises:
completing, by the band, establishment of the communications connection to the terminal.

7. The method according to claim 6, wherein the band comprises a temperature sensor, and the method comprises:
detecting, by the band using the temperature sensor, a time period in which temperature meets a preset abnormality condition, wherein the preset abnormality condition is that the temperature is not within a preset temperature range; and
clearing, by the band, the unlocking password when the time period is longer than a preset time period.

8-14. (canceled)

15. A terminal used for a communications system, wherein the communications system comprises the terminal and a band, a transmit electrode is disposed at a first location on the terminal, a receive electrode is disposed at a second location on the terminal or disposed at a third location on the band, and the terminal further comprises at least one first processor, an analog front end (AFE), and an interface circuit, wherein
the at least one first processor is configured to control, using the AFE, the transmit electrode of the terminal to send a bioelectric current;
the interface circuit is configured to complete establishment of a communications connection between the terminal and the band when the receive electrode receives the bioelectric current; and
the interface circuit is further configured to receive an unlocking password sent by the band, and perform unlocking according to the unlocking password.

16. The terminal according to claim 15, wherein the at least one first processor is configured to:
when the terminal meets a preset pickup condition, control, using the AFE, the transmit electrode of the terminal to send the bioelectric current, wherein the preset pickup condition is that a path is formed between the transmit electrode and the receive electrode, and the path is used to transmit the bioelectric current.

17. The terminal according to claim 15, wherein the interface circuit is configured to:
detect Bluetooth signal strength between the terminal and the band;
determine a distance from the band to the terminal according to the signal strength; and
complete establishment of the communications connection between the terminal and the band when the distance is within a preset distance range.

18. The terminal according to claim 16, wherein the interface circuit is further configured to perform pairing with the band using Bluetooth, and establish authentication.

19. The terminal according to claim 15, wherein the first location and the second location are respectively on two sides of the terminal, and the two sides are parallel to each other.

20. A band used for a communications system, wherein the communications system comprises a terminal and the band, a transmit electrode is disposed at a first location on the terminal, a receive electrode is disposed at a third location on the band, the terminal further comprises at least one first processor and an analog front end (AFE), and the band comprises an interface circuit, wherein
the interface circuit is configured to complete establishment of a communications connection between the band and the terminal when the at least one first processor of the terminal controls, using the AFE, the transmit electrode of the terminal to send a bioelectric current and the receive electrode receives the bioelectric current; and
the interface circuit is further configured to send an unlocking password to the terminal, wherein the terminal performs unlocking according to the unlocking password.

21. The band according to claim 20, wherein the band comprises a temperature sensor and at least one second processor, wherein
the temperature sensor is configured to detect a time period in which temperature meets a preset abnormality condition, wherein the preset abnormality condition is that the temperature is not within a preset temperature range; and
the at least one second processor is configured to clear the unlocking password when the time period is longer than a preset time period.
